(19) United States
(12) Patent Application Publication
(10) Pub. No.: US 2019/0236665 A1
(43) Pub. Date: Aug. 1, 2019

(54) SYSTEM AND METHOD FOR ADAPTIVE MOBILE APPLICATION

(71) Applicant: MOZIDO, INC., Austin, TX (US)

(72) Inventors: Michael A. Liberty, Windermere, FL (US); Mike Love, Austin, TX (US); Steve Bacastow, Cumming, GA (US); Teri Harwood, Austin, TX (US); Aliaksandr Manusovich, Austin, TX (US); Tiago Soromenho, Austin, TX (US); Blake Love, Austin, TX (US)

(21) Appl. No.: 16/379,444

(22) Filed: Apr. 9, 2019

Related U.S. Application Data
(63) Continuation-in-part of application No. 16/246,159, filed on Jan. 11, 2019.
Application No. 16/246,159 is a continuation of application No. 14/601,006, filed on Jan. 20, 2015, now Pat. No. 10,255,625.
(60) Provisional application No. 61/930,227, filed on Jan. 22, 2014.

(51) Int. Cl. G06Q 30/06; H04W 4/30; G06Q 30/02

(52) U.S. Cl. CPC G06Q 30/0601; H04W 4/18; G06Q 30/0226; H04W 4/30

(57) ABSTRACT

Improved techniques for adapting the look, feel, and/or behavior of a mobile application based on user attributes, location, and/or environment in which it is used are described herein. A triggering condition is determined to be satisfied between a hand-held device and a beacon. Based on the triggering condition being satisfied, one or more application settings are applied to an adaptive application, where these settings are associated with the beacon. Additionally, in response to fetching or acquiring an application skin that is associated with the beacon, the application skin is also applied to the adaptive application.

### RELATED APPLICATIONS

This application is a continuation-in-part of U.S. patent application Ser. No. 16/246,159 filed on Jan. 11, 2019, entitled “SYSTEM AND METHOD FOR ADAPTIVE MOBILE APPLICATION”, which is a continuation of U.S. patent application Ser. No. 14/601,006 filed Jan. 20, 2015, entitled “SYSTEM AND METHOD FOR ADAPTIVE MOBILE APPLICATION”, which claims priority to and the benefit of U.S. Provisional Patent Application 61/930,227, entitled “SYSTEM AND METHOD FOR ADAPTIVE MOBILE APPLICATION”, filed on Jan. 22, 2014, all of which are incorporated herein by reference.

### COPYRIGHT NOTICE

A portion of the disclosure of this patent document may contain material, which is subject to copyright protection. The copyright owner has no objection to the facsimile reproduction by anyone of the patent document or patent disclosure as it appears in the U.S. Patent and Trademark Office patent file or records, but otherwise reserves all copyright rights whatsoever.

### BACKGROUND

There has been a significant increase in the use of smart phones among people from all socio demographic backgrounds, ages, professions, and educational levels. At the same time, the number of smart phone applications available either for free or purchase is increasing exponentially. While smart phones have a very high capacity to store new applications, smart phones have a limited amount of space to reasonably display and conveniently launch applications. As the number of installed applications on a given consumer's device increases, the consumer may become reluctant to download and install new applications, particularly if the consumer has another similar (incumbent) application. As a result, the smart phone default screen has become a coveted destination for businesses and application developers alike.

For example, a consumer may have installed a payment or mobile wallet application on his/her smart phone that is designed specifically to work with a single merchant or franchise such as a restaurant, a clothing shop or a sporting goods store. As shown in FIG. 1 (prior art), a smartphone may be configured to store a maximum number of twenty-four applications on the default screen. As shown, eight of twenty-four (or ⅓ of the applications) are dedicated to specific merchants including Merchant A, Merchant B, Merchant C, Merchant D, Merchant E, Merchant F, Merchant G, Merchant H. This leaves only sixteen available spots on the main launch screen of the phone for other applications. Many users limit the number of merchant-specific applications that they have on their phone.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

Embodiments described herein provide methods, systems/devices, and storage media that allow smart phone applications to adapt in look, feel, functionality and behavior based on user attributes, location, and/or other factors as described herein. Embodiments allow a single application to be installed on a smart phone and adapt its behavior and use based on a variety of trigger factors, such as, but not limited to, location and user attributes.

In some embodiments, a hand-held portable device includes a display, processors, and storage media. The device is specially configured to provide merchant (or any kind of organization or association) specific functionality and visual appearance for multiple different merchants. To do so, the device initially determines that a triggering condition is satisfied as between the hand-held portable device and a beacon. Based on the triggering condition being satisfied, the device determines that one or more application settings are to be applied to an adaptive application that is operable on the device. Here, the application settings are settings associated with the beacon. The device then applies the settings to the adaptive application. In response to acquiring an application skin that is associated with the beacon, the device applies the application skin to the adaptive application. Consequently, the application settings are applied to the adaptive application, and the application skin is also applied to the adaptive application.

Embodiments described herein can thus provide an adaptive application that can adapt itself to multiple environments while only using a single launch icon on a smart phone (default or other) screen.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 (PRIOR ART) illustrates the limitations of the current art whereby a given smart phone can have multiple merchant applications.

FIG. 2 illustrates an example proposed whereby a single adaptive merchant application is installed, thus freeing up space to launch other non-merchant applications.

FIG. 3 illustrates a computing architecture in which merchant-specific functionality is provided for a plurality of different merchants based on location.

FIG. 4 illustrates a flowchart of a method for providing merchant-specific functionality for a plurality of different merchants.

FIG. 5 illustrates an embodiment in which an application skin is dynamically changed upon entering another merchant's location.

FIG. 6 illustrates a computing architecture in which merchant-specific functionality is provided for a plurality of different merchants based on triggers.

FIG. 7 illustrates a process flow describing the sequence of steps that may be followed to launch the application.

FIG. 8 illustrates a process flow describing the sequence of steps that may be followed to locate a store.

FIG. 9 illustrates a process flow describing the sequence of steps that may be followed to review and redeem coupons.

FIG. 10 illustrates a process flow describing the sequence of steps that may be followed to review and redeem rewards.

FIG. 11 illustrates a sequence diagram describing some beneficial interactions between the user, mobile device, surroundings, core, and the loyalty system in connection with a coupon redemption.

FIG. 12 illustrates a sequence diagram describing some beneficial interactions between the user, mobile device, surroundings, core, and the loyalty system in connection with a loyalty redemption.

FIG. 13 illustrates an example embodiment of a user interface which includes a company name, a promotional area, and advertising or application content.

FIG. 14 illustrates an example of an application executing on a mobile device, where the skin of the application is dynamically updatable in response to one or more triggering conditions.

FIGS. 15A and 15B illustrate an example scenario in which the skin of an application executing on a mobile device is dynamically updated in response to a triggering condition, where, in this case, the triggering condition is a determination that the mobile device is sufficiently proximate to a beacon (e.g., a network location or a physical location).

FIG. 16 illustrates a flowchart of an example method for dynamically updating the visual appearance (e.g., the skin) of an adaptive application.

### DETAILED DESCRIPTION OF THE INVENTION

Embodiments described herein provide methods and systems that allow smart phone applications to adapt in look, feel, functionality and behavior based on user attributes, location, and/or other factors as described herein. Embodiments allow a single application to be installed on a smart phone and adapt its behavior and use based on a variety of factors such as location and user attributes.

In some embodiments, a hand-held portable device is configured to provide organization-specific functionality and visual appearance. To do so, the device determines that a triggering condition is satisfied as between the hand-held portable device and a beacon. Based on the triggering condition being satisfied, the device determines that certain application settings are to be applied to an adaptive application on the device, where the application settings are associated with the beacon. The device then applies the settings to the adaptive application and acquires an application skin associated with the beacon. The device then applies the application skin to the adaptive application. Consequently, both the application settings and the application skin are applied to the adaptive application.

### Example Computer System

Embodiments described herein may comprise or utilize a special purpose or general-purpose computer including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computer system. Computer-readable media that store computer-executable instructions in the form of data are computer storage media. Computer-readable media that carry computer-executable instructions are transmission media. Thus, by way of example, and not limitation, embodiments described herein can comprise at least two distinctly different kinds of computer-readable media: computer storage media and transmission media.

Computer storage media includes RAM, ROM, EEPROM, CD-ROM, solid state drives (SSDs) that are based on RAM, Flash memory, phase-change memory (PCM), or other types of memory, or other optical disk storage, magnetic disk storage or other magnetic storage devices, or any other medium which can be used to store desired program code means in the form of computer-executable instructions, data or data structures and which can be accessed by a general purpose or special purpose computer.

As used herein, the term “executable module,” “executable component,” “engine,” “module,” or even “component” can refer to software objects, routines, or methods that may be executed on a computer system. The different components, modules, engines, and services described herein may be implemented as objects or processors that execute on a computer system (e.g. as separate threads). It will be appreciated that engines, modules, or components may be a combination of one or more processors and executable instructions that cause the processor(s) to perform specialized functions, such as those described throughout this disclosure and in particular with relation to each individual method act described herein.

A “network” is defined as one or more data links and/or data switches that enable the transport of electronic data between computer systems and/or modules and/or other electronic devices. When information is transferred or provided over a network (either hardwired, wireless, or a combination of hardwired or wireless) to a computer, the computer properly views the connection as a transmission medium. Transmission media can include a network which can be used to carry data or desired program code means in the form of computer-executable instructions or in the form of data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”), and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that various embodiments may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. Embodiments described herein may also be practiced in distributed system environments where local and remote computer systems that are linked (either by hardwired data links, wireless data links, or by a combination of hardwired and wireless data links) through a network, each perform tasks (e.g. cloud computing, cloud services and the like). In a distributed system environment, program modules may be located in both local and remote memory storage devices.

In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

For instance, cloud computing is currently employed in the marketplace so as to offer ubiquitous and convenient on-demand access to the shared pool of configurable computing resources. Furthermore, the shared pool of configurable computing resources can be rapidly provisioned via virtualization and released with low management effort or service provider interaction, and then scaled accordingly.

A cloud computing model can be composed of various characteristics such as on-demand self-service, broad network access, resource pooling, rapid elasticity, measured service, and so forth. A cloud computing model may also come in the form of various service models such as, for example, Software as a Service (“SaaS”), Platform as a Service (“PaaS”), and Infrastructure as a Service (“IaaS”). The cloud computing model may also be deployed using different deployment models such as private cloud, community cloud, public cloud, hybrid cloud, and so forth. In this description and in the claims, a “cloud computing environment” is an environment in which cloud computing is employed.

Additionally or alternatively, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), and other types of programmable hardware.

Still further, system architectures described herein can include a plurality of independent components that each contributes to the functionality of the system as a whole. This modularity allows for increased flexibility when approaching issues of platform scalability and, to this end, provides a variety of advantages. System complexity and growth can be managed more easily through the use of smaller-scale parts with limited functional scope. Platform fault tolerance is enhanced through the use of these loosely coupled modules. Individual components can be grown incrementally as business needs dictate. Modular development also translates to decreased time to market for new functionality. New functionality can be added or subtracted without impacting the core system.

### Improved Adaptive Application Functionalities

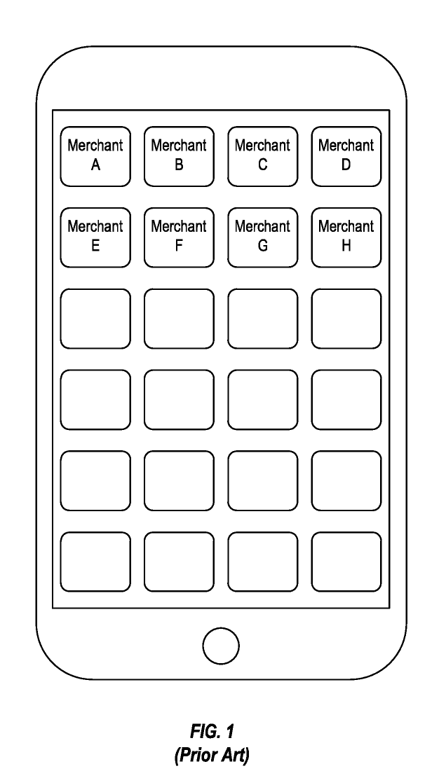

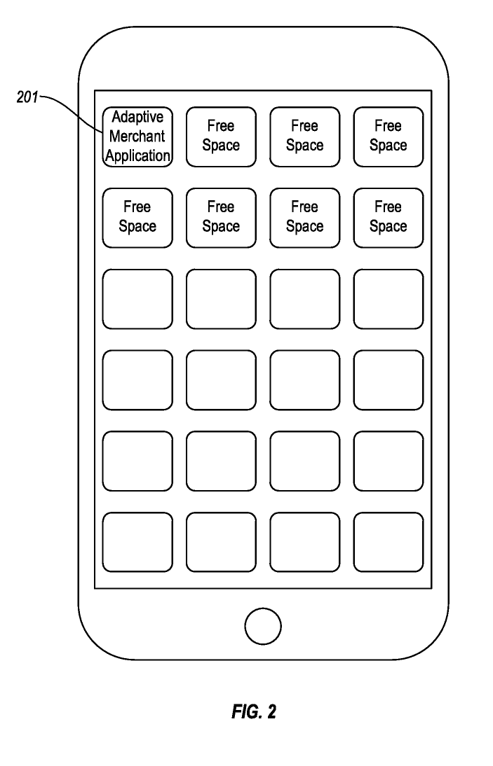

As shown in FIG. 2, a single adaptive merchant application 201 is installed on a mobile device (e.g. a phone). When compared to FIG. 1, an additional seven spots are freed up for other applications on the main launch screen. The single adaptive merchant application may be configured to work with different merchants (or other organizations), and take on a new look and feel for each merchant. Moreover, different application functionality may be provided for each merchant. In one embodiment, the adaptive merchant application can be designed to change its background color (e.g., its “skin”) and functions based on the location, time of day, various triggers and/or user preferences. Triggers may include one or more of the following: a location derived from a geofence, a data signal received from a beacon, an audio signal received, a scanned image or user input. Combinations of triggers can be used to determine specific configuration changes.

In one example, a music player application may adapt itself, when used by a child of a certain age, to consider the optimal ergonomic presentation for a child. When used by an adult, the music player application again adapts to suit the adult's ergonomic preferences. A biometric factor of the user may be used as a trigger to cause the application to adapt in accordance with configured settings. General biometric factors may be used to determine, for example, the age of the user. These general factors can be voice print, facial scan or other factors which are indicative of age. Other specific biometric factors may be pre-registered and associated with a registered user of the application. Such biometric factors may include a user's fingerprint, a facial scan, a voice print or other specific biometric factors of the registered user.

Furthermore, considering a music player application, based on the age of the user and potentially other demographic user information, the music player application may determine what type of music to play, or may offer different music for sale or for download, or may restrict certain songs (e.g. explicit songs) for minors. Additionally or alternatively, the same music player application can adapt itself based on its location in such a way as to prioritize dance songs on a running route, or spiritual songs during typical church hours (or when near or inside a church), or kids' songs if traveling to a specific location (e.g. Grandma's house). As will be evident to one skilled in the art, these are merely a few examples of one application (a music player). The adaptive merchant application may be any of a wide variety of applications, or may include functionality of different (known) applications. As such, the above example is not intended to be limiting.

Using these same ideas, a group of merchants located in a consolidated area such as a shopping mall can agree to subscribe to a common mobile loyalty application. Similarly, individual merchants or franchise owners may also agree to subscribe to a common mobile loyalty application. When used at Merchant A's location, the color and branding of the mobile application may change to adapt to the preferences of Merchant A, and coupons and offers within the application may be specifically targeted for Merchant A. Then, when the same adaptive merchant application is used at Merchant B's location, the color, branding, coupons, offers, etc. would correspond to Merchant B. When used at Merchant A's location, the consumer's default payment preferences can be used for Merchant A. Then, when the same application is used at Merchant B's location, the user's payment preferences for Merchant B would be used. For example, if Merchant A is for example Macy' s department store, a consumer might configure their mobile payment application to always use their registered Macy' s store credit card as the default payment card. If Merchant B is Ruth's Chris Steak House, the consumer may prefer to use their registered American Express credit card. Again, these are merely a small number of examples among many possible examples.

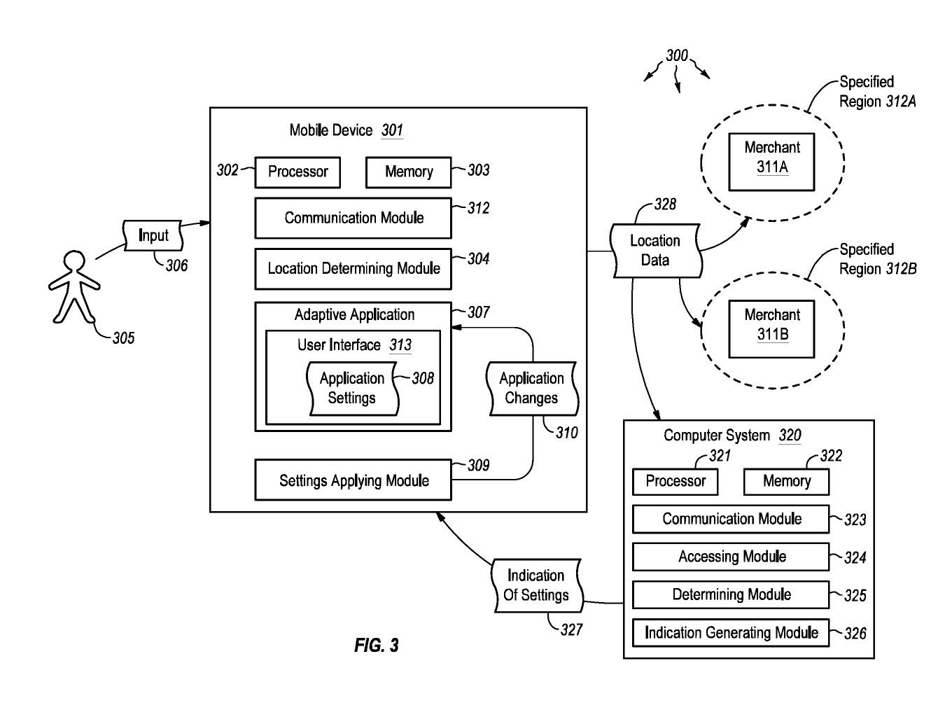

FIG. 3 describes a computing environment 300 in which a mobile device is used in a specific location. The mobile device 301 may be any type of mobile computing system including a smart phone, a feature phone, a tablet, a laptop, a smart watch or any other portable computing system capable of running executable code. The mobile device 301 includes at least one processor 302 and memory 303, as well as a communications module 312. The communications module 312 may include a receiver, a transmitter, or a transceiver capable of both transmitting and receiving data. The communications module 312 may, for example, receive wireless signals from beacons, antennae or other devices associated with merchants 311A and 311B. Communications between the mobile device and the devices of the merchants may notify the merchants that the user has entered their premises and, may also indicate to the adaptive application 307 that it is to change to take on the look and feel of the merchant.

While described in relation to different merchants (e.g. merchants 311A and 311B), it will be understood that the adaptive application 307 can be adapted based on its location regardless of where it is. As mentioned in one example above, a music player application may change based on determining that the user is on a running route. Similarly, an adaptive merchant application 307 may adapt based on a determination that it is near a specific merchant or group of merchants. Moreover, it will be understood that the terms “adaptive application” and “adaptive merchant application” both refer to an adaptable application, while the more specific “adaptive merchant application” refers to a specific use of the adaptive application 307 with merchants.

The mobile device 301 may include other modules for performing different types of functionality. For example, the mobile device 301 may include a settings applying module 309 that applies application changes 310 to the adaptive application. These changes may alter various application settings 308 including skins associated with the application, the placement of buttons, images, video, text or other application-related items. In some cases, the adaptive application 307 may take on the general look and feel of a merchant. In other cases, the adaptive application may take on a specified group of settings based on an outdoor location, or a user-identified location.

The computing environment 300 of FIG. 3 may also include other computer systems such as computer system 320. Computer system 320 may belong to one of the merchants or may belong to some other entity. The computer system 320 may be a distributed computing system such as a cloud computing system, or may be a local or mobile computing system. Like the mobile device 301, the computer system 320 includes at least one hardware processor 321 and memory 322, as well as a communications module 323. The computer system 320 may also include a data accessing module that accesses location indicators 328 sent out by the mobile computing device 307. The determining module 325 of computer system 320 may be configured to determine a user's location and determine that if the mobile device is in a certain location, that a certain set of settings are to be applied to the adaptive application 307. The indication generating module 326 may then generate an indication 327 of the settings that are to be applied to the adaptive application 307. These changes may be applied dynamically within the application, even if it is already running under different settings. These concepts will be explained further below with regard to methods 200 and 300 of FIGS. 2 and 3, respectively.

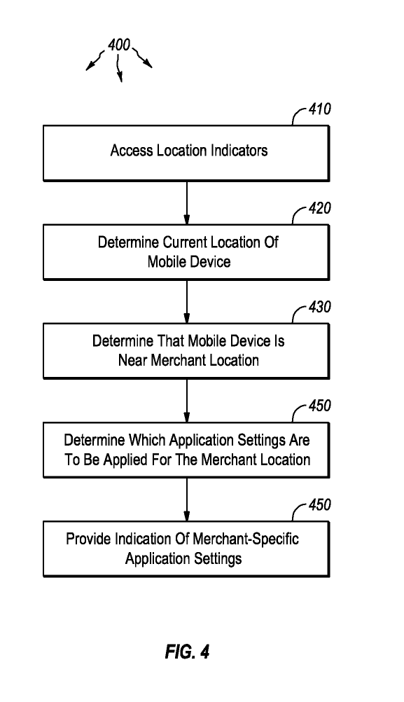

In view of the systems and architectures described above, methodologies that may be implemented in accordance with the disclosed subject matter will be better appreciated with reference to the flow chart of FIG. 4. For purposes of simplicity of explanation, the methodologies are shown and described as a series of blocks. However, it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

### Example Method(s)

The following discussion refers to a number of method acts that may be performed. It should be noted, that although the method acts may be discussed in a certain order or illustrated in a flow chart as occurring in a particular order, no particular ordering is necessarily required unless specifically stated, or required because an act is dependent on another act being completed prior to the act being performed.

As shown in FIG. 4, a method 400 is illustrated for providing merchant-specific functionality for a plurality of different merchants. The computer system 320 may access location indicators 328 received in a data structure from mobile device 307 (410). The computer system 320 may receive location data from the mobile device 301 (which used its own location determining module 304 to determine its location), or may determine the mobile device's location based on other data received from the mobile device (such as a WiFi signal). The determining module 320 may then determine, based on the location indicators, a current location of the mobile device (420), and further determine, based on the mobile device's current location, that the mobile device is within a specified region in relation to a merchant location (430).

As shown in FIG. 3, the mobile device 301 may be within specified region 312A near merchant 311A, or within specified region 312B near merchant 311B. The location determining module 304 of the mobile device 301 may use a variety of different methods to determine the mobile device's current location and/or to determine whether the user is within a specified region (e.g. near a merchant, on a running trail, near a church, near a movie theater, etc.). The location may be determined using cellular geo-location (e.g. using GPS), in-store detection of a (low energy) blue tooth signal, in-store detection based on sound emitted by a speaker (e.g. high-pitched sound inaudible to human ears), active scanning of a QR code during a check in process, or passive scanning of a merchant location from an invisible watermark. Other methods of location detection may also be used. As the user moves from store to store, or place to place, the look and feel and/or the functionality of the adaptive application may change automatically (or at the request 306 of the user 305).

Continuing with the flowchart of FIG. 4, the computer system may further determine that one or more of a plurality of merchant-specific application settings are to be applied to an application on the mobile device, where the merchant has specified one or more merchant-specific application settings that are to be applied to the application when the mobile device is within the specified region in relation to the merchant location (440). The computer system then providing an indication of which merchant-specific application settings are to be applied to the application on the mobile device (450) such that the determined application settings are applied to the adaptive application on the mobile device 301.

Thus, if computer system 320 determines that the mobile device 301 is at merchant 311A (i.e. is within the specified region 312A in or around merchant 311A′ s physical location, the indication generating module 326 may generate indication of settings 327 which indicates those settings that are to be applied to the adaptive application 307. This indication of changes may cause an automatic and dynamic updating of application settings 308. These settings may include an indication of which application skin to use, or which payment account to use when paying for an item) or may change the actual functionality of the adaptive application 307. These changes may be implemented automatically and dynamically as the user moves from store to store (such as within a mall). As a single application may now be used with many different merchants, users may remove many of the merchant-specific applications off of their phones, freeing up valuable home screen real estate, and allowing for much more efficient user interactions with the mobile device.

As mentioned above, the application settings 308 may include at least one payment account preference indicating which payment account is to be used when purchasing items from that merchant. In some cases, the adaptive application 307 is a mobile wallet application, or includes mobile wallet functionality. In such cases, the mobile wallet application would include access to various payment accounts including debit accounts, credit accounts, loyalty points or other value stores. The user may have payment preferences for different stores. For example, the user may wish to use a store-specific credit card for payment at merchant 311A, and may wish to use a debit card at merchant 311B. These payment preferences may be received from the user 305 (e.g. in input 306) at the time or purchase or at some earlier point in time (such as during application registration), and may be applied automatically during the time of purchase. In this manner, the user may shop at multiple different stores and pay for items using store-specific credit cards at each store, all while using the same adaptive merchant application 307. Optionally, the user may use the specified default payment account when shopping at a given merchant, or may override the default and specify which account the payment is to be drawn from.

In another embodiment, when a user goes to a specific merchant location (e.g. 311A), the settings applying module 309 may select one or more merchant-specific coupons or offers based on the determined merchant location, and apply the coupons or offers automatically upon checkout. For instance, if merchant 311A is a restaurant, and the user has dined there previously and has accrued loyalty points, or has otherwise received coupons or offers (e.g. via email or text directly to the mobile device 301), these loyalty points, coupons or offers may be applied when the user pays for the bill using the adaptive merchant application 307. The user's default payment account may be used in conjunction with the points/coupon/offer to cover the full balance. As a result of the user's purchase, the user 305 may accrue additional restaurant-specific loyalty points for purchasing from that merchant location. Similarly, if other (perhaps commonly owned) stores provide loyalty points or coupons, the user may receive those points in their adaptive merchant application for use in subsequent visits. Furthermore, in some cases, users may receive coupons or loyalty points simply for being in the store. As such, the adaptive application 307 may be updated to reflect these coupons or loyalty points upon entering the merchant's premises.

Still further, as mentioned above, the application settings 308 may include a skin preference for the determined merchant. Thus, for example, if a user has entered within the specified region 312B (e.g. a geofence defined by GPS coordinates), the adaptive merchant application 307 may apply a skin that is specific to merchant 311B. The skin may include graphics, colors, trademarks, logos or other characteristics of merchant 311B. Thus, the application will have the look and feel of the merchant. As such, merchants may provide desired skins for use by the adaptive application. The user, however, may be able to override the merchant's preference and use their own skin, or the adaptive application's own native skin.

The skin may be applied automatically upon entering the determined merchant location. Thus, if the user is at a mall and enters a game store, the adaptive application may take on the skin for the game store. The skin may be automatically applied as the user enters the specified region, and may be applied dynamically even when the application is already open. Similarly, if the application is not open, the icon for the application may be changed to include a store-provided icon or may include watermarks or other features indicative of that store. Then, as the user moves to another store, restaurant or other location, that store's store-specific settings are automatically applied to the application. In this manner, a user may install one adaptive application that can be used in a variety of situations to provide different functionality, and may change its look and feel based on location.

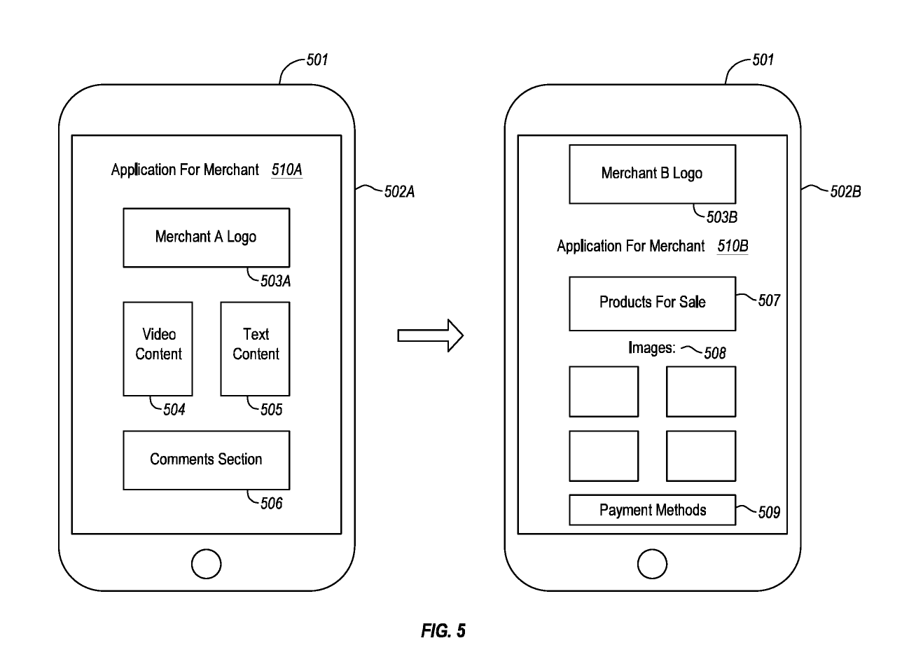

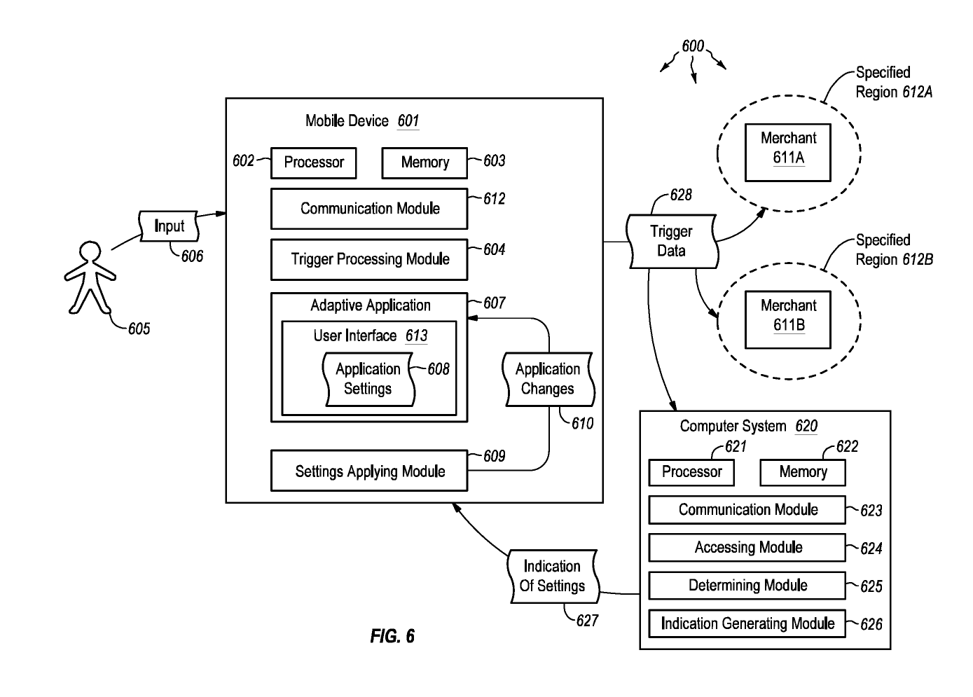

One example embodiment of an adaptive application is shown in FIG. 5. A mobile device 501 such as a mobile phone runs an application for a merchant. The adaptive application may be run for one merchant 510A (or other entity), while the same adaptive application may be run for another merchant 510B (or other entity). The adaptive application may have a skin 502 which includes certain backgrounds, application layouts, colors, fonts, images, logos or other elements associated with an application skin. Thus, as can be seen in FIG. 5, the skin 502A for merchant 510A includes Merchant A's logo, below which video content 504, text content 505 and a comments section 506 may be found. Whereas the skin 502B for Merchant B may include the Merchant B logo 503B along with various products for sale 507, images of products 508, and may further include a button that allows the user to select the method of payment 509. Accordingly, the same adaptive application may include different logos, different layouts, different color schemes, different content and different placement of items on the screen. As such, the adaptive application may take on an entirely new form when located in different locations.

In another embodiment, a computer system 320 is provided that includes processor 321, a communications module 323 (e.g. a transceiver), and a data accessing module 324 configured to access location indicators received by the transceiver, where the location indicators 328 are transmitted in a data structure from a mobile device. The computer system 320 further includes a determining module 325 that performs the following: determines, based on the accessed location indicators in the received data structure, a current location of the mobile device, determines, based on the determined current location of the mobile device, that the mobile device is within a specified region in relation to a merchant location, and determines that merchant-specific application settings are to be applied to an adaptive application on the mobile device, where the merchant has specified merchant-specific application settings that are to be applied to the adaptive application when the mobile device is within the specified region in relation to the merchant location. The computer system further includes an indication generating module 326 that generates an indication of application settings 327 that are to be applied to the adaptive application on the mobile device.

In some cases, the settings applying module 309 of the mobile device 301 is configured to receive the indication of settings 327 from the computer system 320 and apply the merchant-specific application settings to the adaptive application even if the adaptive application is already open. As shown in FIG. 5, the merchant-specific application settings for one merchant provide at least some portion of application functionality that is different than application functionality provided by another merchant. The merchant-specific application settings may provide access to merchant-specific downloadable features for the adaptive application 307, may provide access to merchant-specific coupons or offers or may provide access to merchant-specific payment options. Indeed, as shown in FIG. 5, the skin 502B for merchant 510B includes a payment options button 509 that may include merchant-specific payment options such as electronic currency (e.g. Bitcoin), store-specific stored value cards (i.e. gift cards), store-specific credit cards or other payment methods.

In another embodiment, a computer program product is provided which comprises one or more computer storage media having thereon computer-executable instructions that, when executed by processor 321 of computing system 320, cause the computing system to instantiate a user interface 313 on a mobile device 301, where the user interface comprises the following: a dynamically changeable skin that is updatable to include merchant-specific elements associated with a merchant, where the dynamically changeable skin changes based on the location of the mobile device, one or more dynamically changeable user interaction elements that allow the user to interact with the application represented by the user interface, where the dynamically changeable user interaction elements change based on the location of the mobile device, and an application data portion that presents application data. Again, as shown in FIG. 5, the skins 502A and 502B associated with Merchants 510A and 510B, respectively, each have different logos, different types of content, different payment methods and other content differences that are not shown.

The user interface 313 of the adaptive application 307 may by dynamically updated as the mobile device changes locations. For example, if a mobile device crosses a geofence, it may have entered the specified region (e.g. 312A) of another merchant, and the adaptive application may adapt dynamically to the new merchant's specified settings. By only having a single application, data storage resources are reduced, and memory usage is reduced as fewer applications are running concurrently. The user interface 313 of the adaptive application is highly efficient and may dynamically change its skin to present the look and feel of different merchants on the application as the user is travelling between stores or other locations. This prevents the user from having to switch to different merchant-specific applications each time they go to a new store or new location. Moreover, the dynamically changeable user interaction elements may present coupons, rewards or other offers to an application user and, upon selection by a user, may apply those coupons or offers to a payment between the user and the merchant. In this manner, a single adaptive application may be used in many different venues, and may take on the characteristics of that venue.

FIG. 6 describes a computing environment 600 in which a mobile device is used in a specific location. The mobile device 601 may be any type of mobile computing system including a smart phone, a feature phone, a tablet, a laptop, a smart watch or any other portable computing system capable of running executable code. The mobile device 601 includes at least one processor 602 and memory 603, as well as a communications module 612. The communications module 612 may include a receiver, a transmitter, or a transceiver capable of both transmitting and receiving data. The communications module 612 may, for example, receive wireless signals from beacons, antennae or other devices associated with merchants 611A and 611B. Communications between the mobile device and the devices of the merchants may notify the merchants that the user has entered their premises and, may also indicate to the adaptive application 607 that it is to change to take on the look and feel of the merchant.

While described in relation to different merchants (e.g. merchants 611A and 611B), it will be understood that the adaptive application 607 can be adapted based on detected triggers regardless of where it is. As mentioned in one example above, a music player application may change based on determining that the user is on a running route. Similarly, an adaptive merchant application 607 may adapt based on a determination that it is near a specific merchant or group of merchants. Moreover, as with FIG. 3, it will be understood that the terms “adaptive application” and “adaptive merchant application” both refer to an adaptable application, while the more specific “adaptive merchant application” refers to a specific use of the adaptive application 607 with merchants.

The mobile device 601 may include other modules for performing different types of functionality. For example, the mobile device 601 may include a settings applying module 609 that applies application changes 610 to the adaptive application. These changes may alter various application settings 608 including skins associated with the application, the placement of buttons, images, video, text or other application-related items. In some cases, the adaptive application 607 may take on the general look and feel of a merchant. In other cases, the adaptive application may take on a specified group of settings based on an outdoor location, or a user-identified location (e.g. after receiving input 606 from user 605).

The computing environment 600 of FIG. 6 may also include other computer systems such as computer system 620. Computer system 620 may belong to one of the merchants or may belong to some other entity. The computer system 620 may be a distributed computing system such as a cloud computing system, or may be a local or mobile computing system. Like the mobile device 601, the computer system 620 includes at least one hardware processor 621 and memory 622, as well as a communications module 623. The computer system 620 may also include a data accessing module that accesses trigger data 628 sent out by the mobile computing device 607. The determining module 625 of computer system 620 may be configured to determine a user's location and determine that if the mobile device is in a certain location, that a certain set of settings are to be applied to the adaptive application 607. The indication generating module 626 may then generate an indication 627 of the settings that are to be applied to the adaptive application 607. These changes may be applied dynamically within the application, even if it is already running under different settings.

The computer system 620 may access trigger signals 628 received in a data structure from mobile device 607 (410). The computer system 620 may receive trigger signal data structures from the mobile device 601 (which used its own trigger processing module 604 to determine the configuration settings). The determining module 620 may then determine, based on the trigger signals, a configuration setting of the mobile device (420.

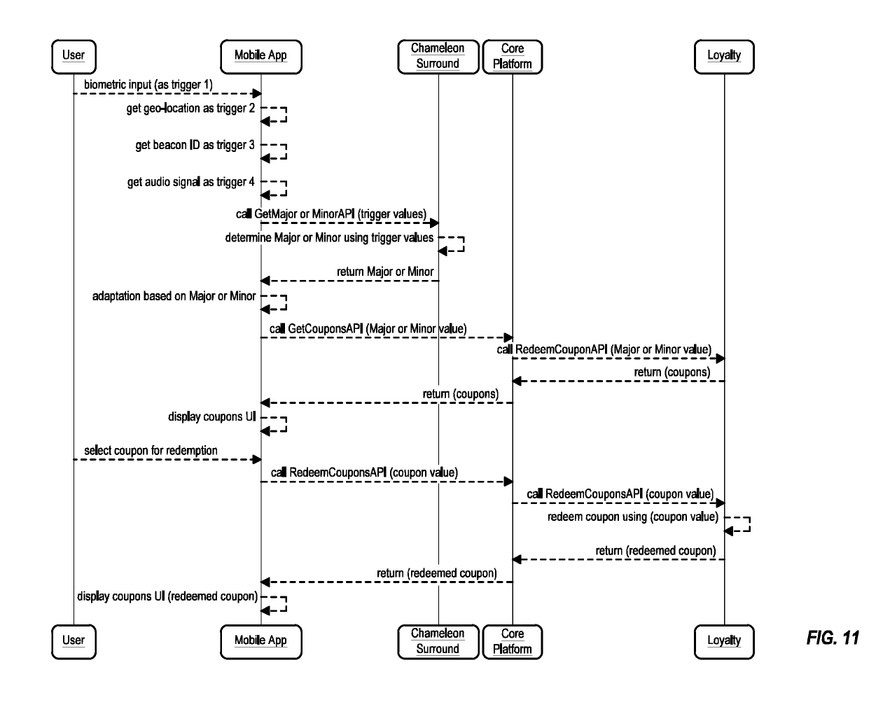

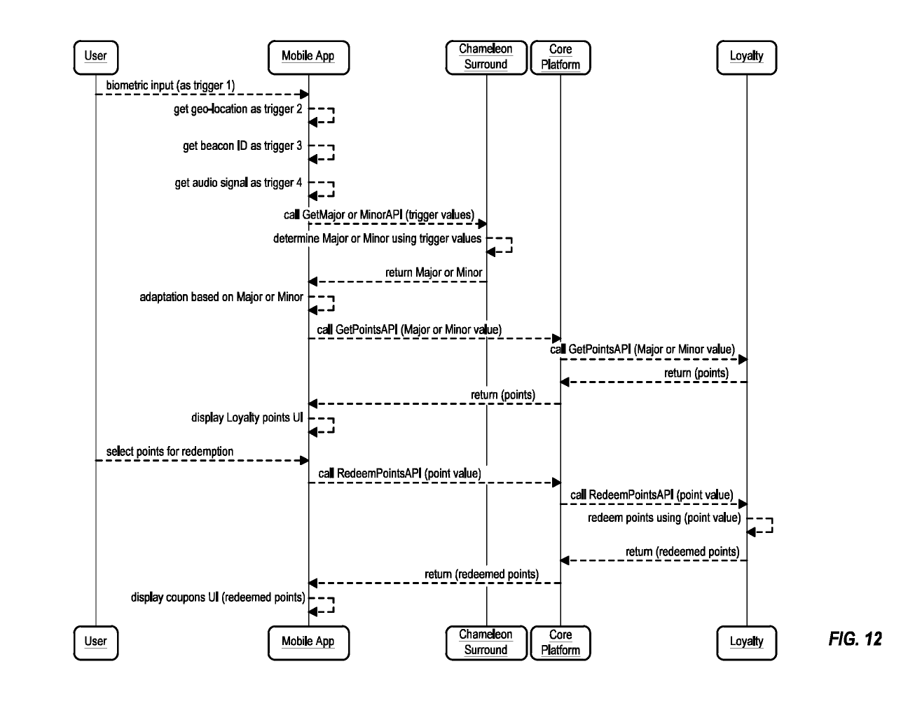

As shown in FIG. 6, the mobile device 601 may be within specified region 612A near merchant 611A, or within specified region 612B near merchant 611B. The trigger processing module 604 of the mobile device 601 may use a variety of different methods to determine the mobile device's configuration settings. Combinations of triggers can be used to determine specific configuration changes as further described in FIGS. 11 and 12 below.

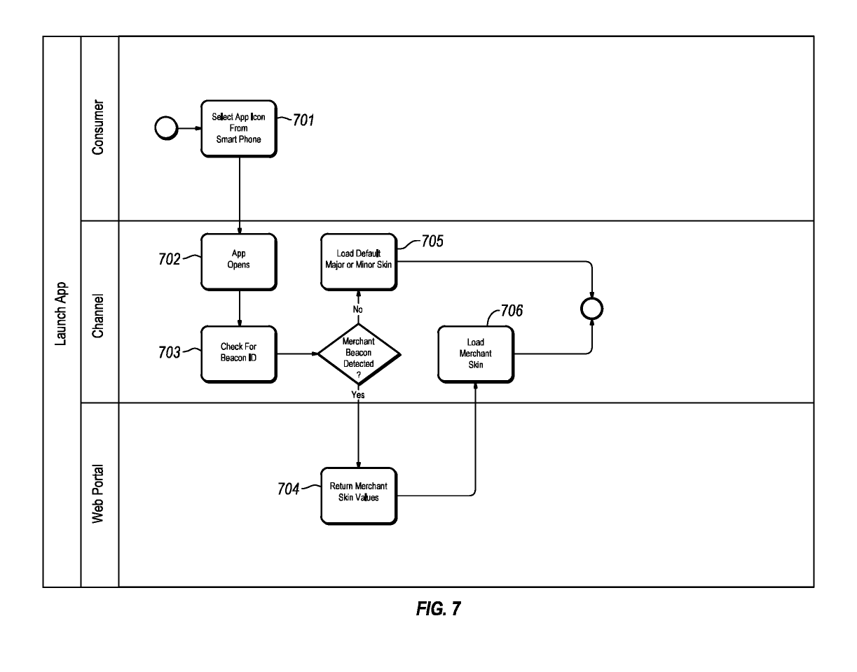

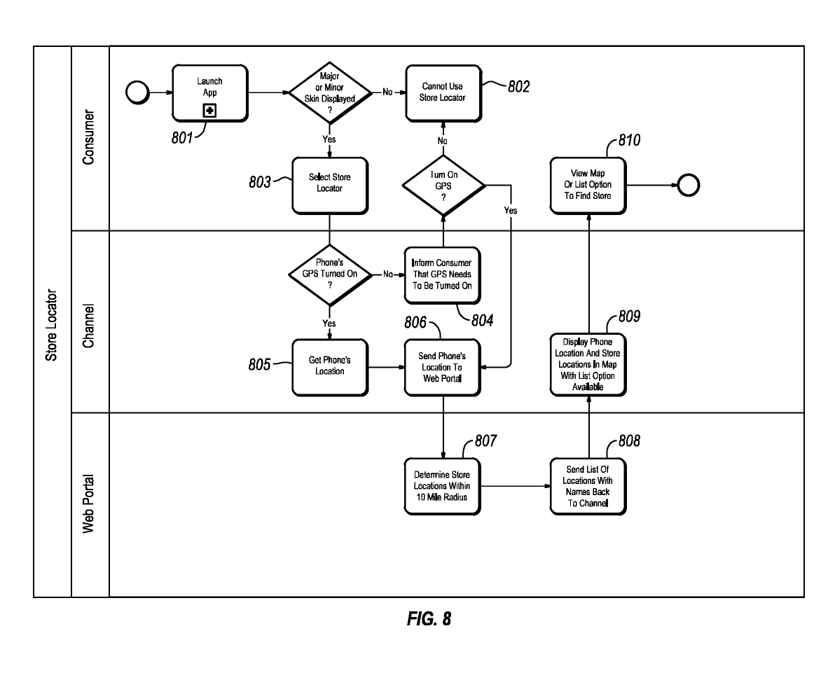

FIG. 7 illustrates an embodiment of a process flow describing a sequence of steps used to launch the application comprised of a consumer, a channel which is a mobile device of the consumer, and a web portal. In step 701, the consumer selects an application icon from a smart phone. In response to the user input, the application opens in the channel (step 702). In step 703, the channel checks for a local beacon ID. In step 704, if a local beacon ID is detected, the web portal delivers the values to the channel, which will allow the channel (at step 706) to configure the user interface (e.g. the UI skin). Alternatively, at step 704, if a local beacon ID is not detected, the channel may load the default skin for the application.

FIG. 8 illustrates an embodiment of a process flow describing a sequence of steps used to locate a store comprised of a channel which is a mobile device of the consumer and a web portal. In step 801, the consumer launches the application. Responding to the input from the consumer, the launched application checks to determine if a default (Major) skin is currently displayed. If not, the application (in step 802) cannot use the store locator function associated with the Major skin. If a Major skin is displayed, using step 803, the store locator function may be activated by the consumer. Upon activating the store locator function, the channel checks to determine if the GPS of the channel is turned on. If the GPS of the channel is not turned on, the channel (at step 804) sends a message to the consumer informing the consumer that the GPS is to be turned on in order to use the store locator function.

In response to the message from the channel, the consumer can turn on the GPS (or other similar radio) of the channel. If the consumer turns on the GPS, the channel sends its location information to the web portal as shown in step 806. If the channel previously determined that the GPS was turned on, the channel obtains its location using step 805, and the channel sends its location information to the web portal as shown in step 806. In response to the message received from the channel, at step 807, the web portal determines store locations within a defined radius based on configuration settings. Having determined the store locations, at step 808, the web portal sends the list of locations back to the channel. At step 809, the channel displays the locations to the consumer. The process is completed with step 810, where the consumer views the list of locations.

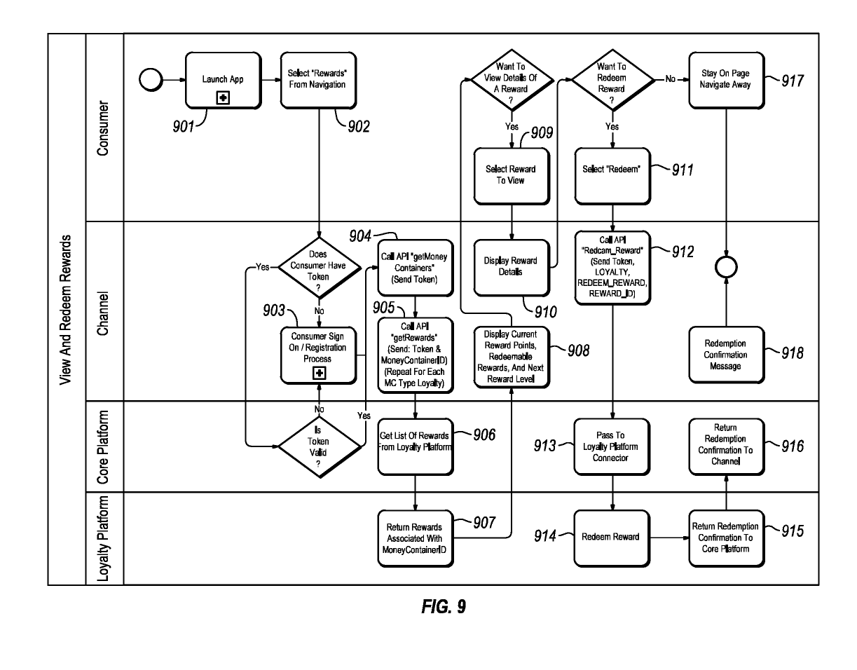

FIG. 9 illustrates an embodiment of a process flow describing a sequence of steps used to review and redeem coupons comprised of a channel which is a mobile device of the consumer, a core processing platform and a loyalty platform. At step 901, the consumer launches the mobile application. At step 902, the consumer selects ‘Rewards’ as an option on the navigation of the mobile application. In response to input from the consumer, the channel determines if the consumer has a token. If the consumer has a token, the token is transmitted to the core platform for validation. If the consumer does not have a token, the consumer registers or signs on to the mobile application (step 903). Although the registration process is not shown in its entirety, the completion of step 903 results in a token which is made available to step 904.

In step 904, the channel calls an API which determines the ID of a money container associated with the registered mobile application of the consumer. The money container ID and associated token are used by step 905 to determine the rewards programs available for the registered consumer. Using the results of step 905, the core platform obtains a list of rewards using an application programming interface (API) of the loyalty platform. At step 907, the loyalty platform returns the list of rewards programs that are currently associated with the registered consumer, and the list is returned to the channel device of the consumer. In step 908, the channel device of the consumer displays one or more of the current rewards points, redeemable rewards, and the next available reward level. In response to the display of reward information, the consumer can determine whether to display the details associated with the rewards programs in step 909.

Responsive to the input of the consumer, the channel displays the reward details at step 910. In response to the display of reward details, the consumer can determine whether to redeem an available reward at step 911. Alternatively, the consumer can step on the navigation page or navigate away at step 917. Responsive to the input by the consumer to ‘Redeem’, the channel calls an API of the core platform which sends a message including parameters designated for the token such as loyalty points, redeem reward, and reward ID. The core platform forwards message to the loyalty platform using step 913. Responsive to the message received from the core platform, the loyalty platform redeems (step 914) the selected rewards of the consumer and creates a redemption confirmation message (step 915) to the core platform. The core platform returns the redemption confirmation message to the channel at step 916. The process is completed in step 918 wherein the channel displays the redemption confirmation message.

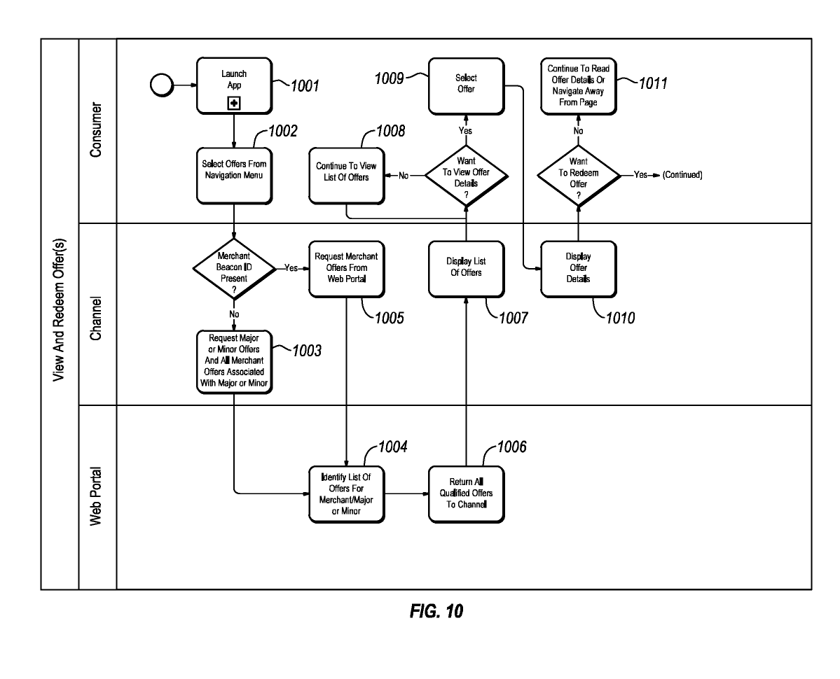

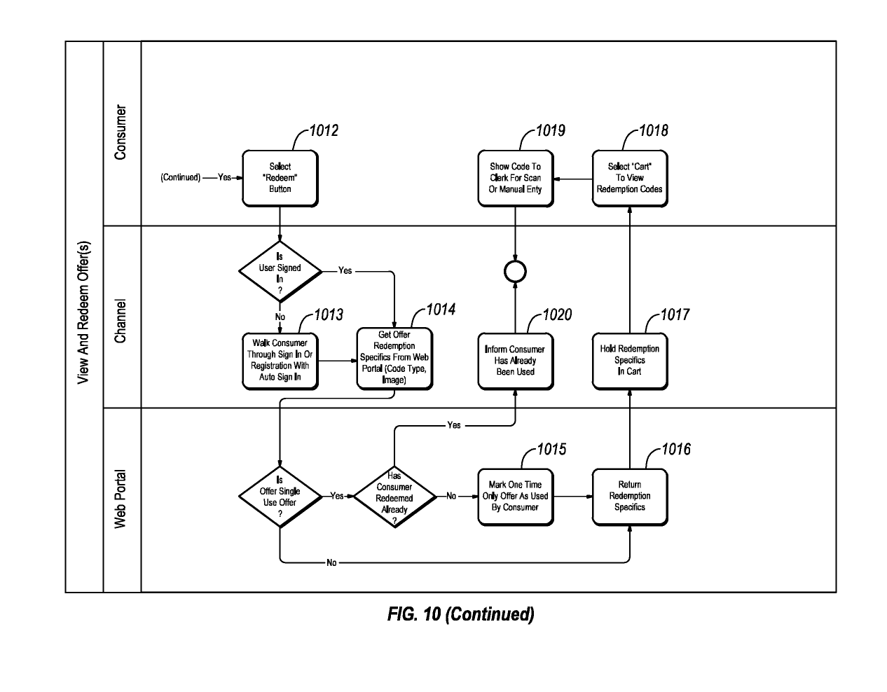

FIG. 10 illustrates an embodiment of a process flow describing a sequence of steps used to review and redeem rewards comprised of a channel which is a mobile device of the consumer and a web portal. The consumer launches the mobile application at step 1001 and selects “Offers” from the navigation menu of the mobile application at step 1002. The channel application determines if a merchant beacon ID is available. If a merchant beacon ID is available, the channel a list of available merchant offers from the web portal in step 1005. If a list of merchants is not available, the channel can request a list of available offers associated with the default (Major) merchant using step 1003. Responsive to the request(s) from the channel, the web portal can identify a list of offers for the consumer in step 1004. The identified list of offers is returned by the web portal to the channel in step 1006. The channel can display the list of offers using step 1007.

Responsive to the display of offers, the consumer can view details associated with an offer (step 1009) or the consumer can continue to view the list of available offers in step 1008. If the consumer selects an offer using step 1009, the channel, responsive to the consumer's selection displays the details of the offer in step 1010. Responsive to the display of offers by the channel, the consumer can continue to view the offer details (step 1011) or the consumer can select a specific offer to redeem using step (1012). If the consumer is not currently signed into the mobile application, the channel facilitates the sign-in or registration process using step (1013). If the consumer is already signed into the mobile application, the channel calls an API to obtain the specific details associated with the offer selected for redemption. A message is sent to the web portal consisting of the redemption code type and redemption code image.

Responsive to the message received from the channel, the web portal determines if the redemption is associated with an offer than be redeemed a single time. If the offer is of a type that can be redeemed a single time and if the consumer has already redeemed the selected offer, the web portal sends a message to the channel informing the consumer that offer has already been used (step 1020). However, if the offer has not been previously redeemed, the web portal marks the offer as used by the consumer in step (1015). The web portal returns a redemption message to the channel in step (1016). Responsive to the message, the channel is operable to hold the redeemed offer in a shopping cart included within the mobile application (step 1017). Responsive to the display of the offer in the shopping cart, the consumer can select ‘cart’ to view the redemption codes using step (1018). At step (1019), the consumer can use the display of the mobile application to show an employee of the merchant the redemption code.

FIG. 11 illustrates an embodiment of a sequence diagram describing interactions between the user, mobile device, surround, core, and the loyalty system in connection with a coupon redemption. The user initiates the coupon redemption process by providing a biometric factor as input to the mobile application. Biometric input may be, for example, a fingerprint, voice, facial scan, or other unique biometric factor of the user. Based on the settings for this user, the mobile application is operable to search for and record multiple additional trigger values as contextual values associated with the environment. Additional trigger values may include geo-location (shown as trigger value 2), a beacon ID (shown as trigger value 3), and an audio signal (shown as trigger value 4).

Having now received the biometric input of the user and at least one additional trigger value, the mobile application is operable to determine the Major or Minor value associated with the current environment. The default setting for the mobile application is considered the Major value. Other settings for the mobile application are each considered Minor values. While there is only one Major value associated with the mobile application, there may be an unlimited number of minor values. If the environment is a merchant location, the Major or Minor value is associated with the merchant. If the environment is a venue other than a merchant (a baseball stadium for example), the Major or Minor value associated with the baseball stadium is returned. If and as the user continues to move within the geofence associated with the Major or Minor value, the mobile application is operable to continue to search for and accept additional trigger values from the environment. The mobile application is operable to adapt its user interface based on the current Major or Minor value and additional trigger values. The mobile application is further operable to use an API (e.g. a “GetCouponsAPI”) using its then Major or Minor value to obtain and display a list of the coupons available to the user. The user can then select and redeem a coupon using the user interface of the mobile application.

FIG. 12 illustrates an embodiment of a sequence diagram describing interactions between the user, mobile device, surround, core platform, and the loyalty platform in connection with a loyalty redemption. The user initiates the loyalty redemption process by providing a biometric factor as input to the mobile application. Biometric input may be one of a fingerprint, voice, facial scan, or other unique biometric factor of the user. Based on the settings for this user, the mobile application is operable to search for and record multiple additional trigger values as contextual values associated with the environment. Additional trigger values may include geo-location (shown as trigger value 2), a beacon ID (shown as trigger value 3), and an audio signal (shown as trigger value 4).

Having now received the biometric input of the user and at least one additional trigger value, the mobile application is operable to determine the Major or Minor value associated with the current environment. The default setting for the mobile application is considered the Major value. Other settings for the mobile application are each considered Minor values. While there is only one Major value associated with the mobile application, there may be an unlimited number of minor values. If the environment is a merchant location, the Major or Minor value is associated with the merchant. If the environment is a venue other than a merchant (a shopping mall for example) the Major or Minor value associated with the shopping mall is returned. If and as the user continues to move within the geo-fence associated with the Major or Minor value, the mobile application is operable to continue to search for and accept additional trigger values from the environment. The mobile application is operable to adapt its user interface based on the current Major or Minor value and additional trigger values. The mobile application is further operable to use the GetPointsAPI using its current Major or Minor value to obtain and display a list of the loyalty points available to the user. The user can then select and redeem loyalty points using the user interface of the mobile application.

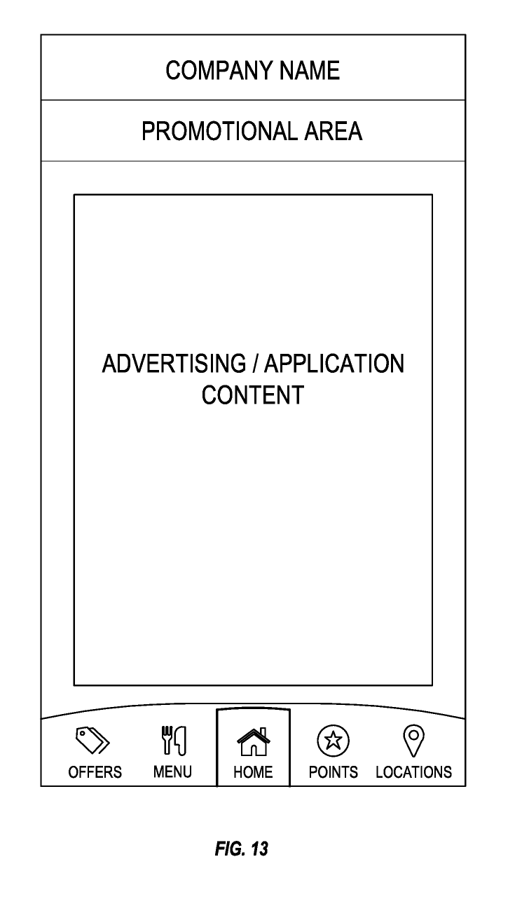

For example, the user may use the user interface shown in FIG. 13 to select and redeem loyalty points. The UI may, for example, show a company name at the top as well as a promotional area that shows current offers or promotions available at that company's store. The advertising area/application content area may show a familiar company logo or a video pictorial advertisement for that company. The consumer may browse the application's UI using any of the buttons displayed at the bottom of the UI including the “Offers” button (which displays available offers), the “Menu” button (which displays a menu for the company in cases where the company is a restaurant), the “Home” button (which takes the user to the main display for that application (i.e. to the Major value or default location), the “Points” button (which shows the user's available loyalty points), or the “Locations” button (which shows other locations of the company's stores). It will be understood that this example UI is just one example and that other navigations buttons may be used, and that other content such as games or product displays or chat applications or other content may be displayed within the UI in addition to or as an alternative to the content shown in FIG. 13.

### Dynamically Changing Skin Appearance In Response To Triggering Conditions

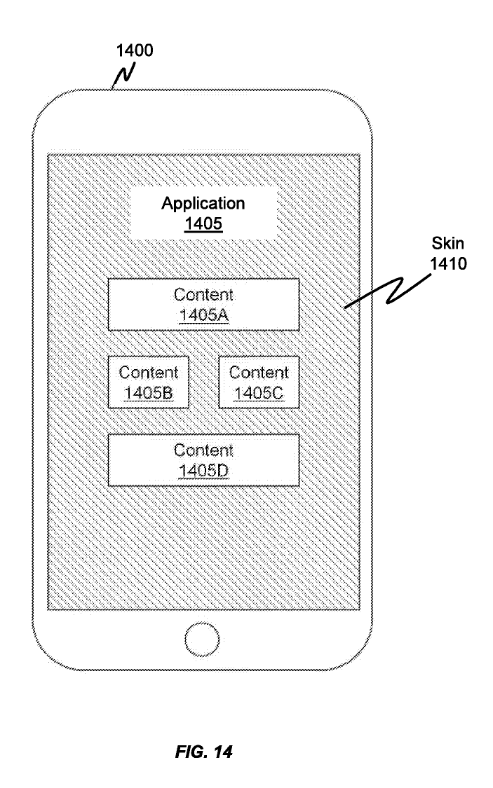

Attention will now be directed to FIG. 14, which illustrates a mobile device 1400 that is executing an application 1405. It will be appreciated that mobile device 1400 may be any type of mobile device (e.g., a phone, laptop, tablet, etc.), and it is not limited to any one particular implementation. As discussed earlier, mobile device 1400 is configured to execute any number of applications, such as application 1405. In the scenario presented in FIG. 14, application 1405 is currently executing on mobile device 1400 and is being displayed on mobile device 1400's display screen. Application 1405 may be associated with any type of entity (e.g., a merchant or organization). For example, application 1405 may be associated with NGOs for charity, churches for services, government organizations, health care providers, and other non-commercial organizations (e.g., clubs, associations, etc.). Application 1405 is an example of an adaptive application, as described throughout this disclosure.

Application 1405 is configured to displayed any amount or type of content on the display. As an example, application 1405 is currently displaying content 1405A, content 1405B, content 1405C, and content 1405D. While only four different pieces of content are currently being displayed, it will be appreciated that any amount can be displayed at a given time. Furthermore, application 1405 can dynamically (e.g., in real time) change the displayed content based on different conditions, such as, but not limited to, user input.

FIG. 14 also shows how application 1405 includes a skin 1410. Skin 1410 should be interpreted broadly and can include the background color or appearance of the application 1405 as well as other features associated with the application 1405 (e.g., audio features, text features, etc.). As an example, skin 1410 can be any combination of a solid background color, a gradient fill color, a picture or texture fill color, a pattern fill color, images, navigation features, or any other type of background appearance, image, or content, or audio feature. In some embodiments, skin 1410 is representative of the “theme” or “feel” of application 1405 (i.e. the application skin visualizes a theme associated with a beacon). As an example, suppose application 1405 is designed for a restaurant. Skin 1410 can thus provide a restaurant-themed background. For instance, the background can include a picture of the inside of a restaurant, or it can include pictures of food or silverware, or it can include pictures of patrons enjoying a meal. It will be appreciated that the skin 1410 can be fully configurable and customizable to represent any type of theme or atmosphere.

As another example, suppose application 1405 was designed for an automotive parts store. Here, skin 1410 may include pictures of vehicles, vehicle parts, mechanics, tools, and so forth as well as sounds associated with the store. By providing these images and/or any other vehicle-related images or audio content, skin 1410 enhances the visual appearance and attractiveness of application 1405. Furthermore, skin 1410 is useful because it can provide an immediate context for the user. That is, by simply looking at or listening to the skin 1410, the user will be able to immediately discern or infer the general scope or type of application 1405. Accordingly, skin 1405 can take on any type of appearance in order to provide context and visual cues for application 1405 as well as audio cues. It will be appreciated, however, that skin 1410 is not limited simply to images, audio, or pictures. For instance, as described above, skin 1410 can be as simple as a uniform background color or it can be as complex as a highly detailed picture. Accordingly, skin 1410 should be interpreted broadly and should include any kind of appearance or audio for application 1405. Skin 1410 can also include any kind of audio assistance application.

According to at least some of the disclosed embodiments, skin 1410 is dynamically updateable in response to one or more triggering conditions. Examples of these triggering conditions include, but are not limited to, (i) the mobile device 1400 being proximate to a beacon (e.g., a proximity between the hand-held portable device and the beacon satisfies a proximity threshold or requirement), (ii) a particular time (e.g., noon) arrives, (iii) a particular time period or frequency elapses (e.g., every 5 minutes, 10 minutes, 30 minutes, 1 hour, 6 hours, 24 hours, etc.), (iv) certain user input triggers a change, or (v) some condition external to the mobile device 1400 causes a change (e.g., an update is pushed to the application). Of course, these are examples of triggering conditions only and any other type of triggering condition may cause the skin 1410 to dynamically change as well. These triggers may cause changes to the skins visual and/or audio characteristics.

As discussed above, one of the triggering conditions includes the mobile device 1400 being proximate to a beacon. As used herein, the term “beacon” should be interpreted broadly. In some cases, a beacon includes a physical location, such as a merchant's store, a park, a home, a building, or any other type of physical location. In some embodiments, a beacon includes a virtual location, such as a location within a network. In some embodiments, a beacon includes a wireless connection such as, but not limited to, a Bluetooth connection, a near-field wireless connection, a GPS based location, a geofence, or any other type of wireless connection.

As additional examples, a beacon can be a particular router or switch within a computing network. As another example, a beacon can be a part of a mobile telecommunications network, such as a base station, a mobile switching center, a serving GPRS support node, a home location register, or any other part of a telecommunications network. Accordingly, a beacon can be an actual physical location or, alternatively, it can be a virtual location or entity (e.g., a network location within a network).

In some embodiments, when the mobile device 1400 becomes near or proximate to a beacon, then the skin 1410 can be dynamically updated to reflect a predetermined relationship with the beacon. As an example, suppose application 1405 is a particular merchant's application or is executing a particular merchant's set of application settings. Further suppose that mobile device 1400 is moved so as to be near the merchant's actual physical location. In response to this movement, some embodiments will dynamically update skin 1410 to emphasize the fact that the mobile device 1400 is now near the merchant's actual location. These updates can include text indicating that the mobile device 1400 is near the actual location, a map in the background showing closeness or proximity, new background color(s), new audio characteristics, or even enhanced images (e.g., an image of the store's front door) displayed in the background. Regardless of what images or audio are used, the skin 1410 can be updated to reflect that mobile device 1400 is proximate to the actual physical location.

When the beacon is a virtual entity or location and when application 1405 is performing operations related to that virtual entity (e.g., perhaps application 1405 is an IT troubleshooting application), then skin 1410 can also update to reflect such a relationship. For instance, in some embodiments, skin 1410 can be updated to include a network topology or map of the network that mobile device 1400 is currently connected to. In any event, skin 1410 can be updated to reflect a relationship between application 1405 and a particular beacon.

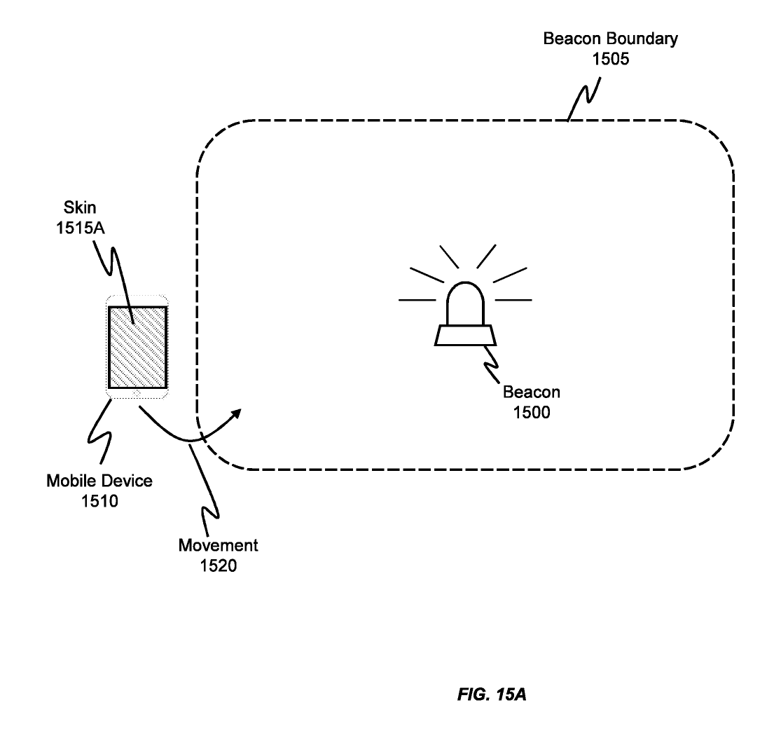

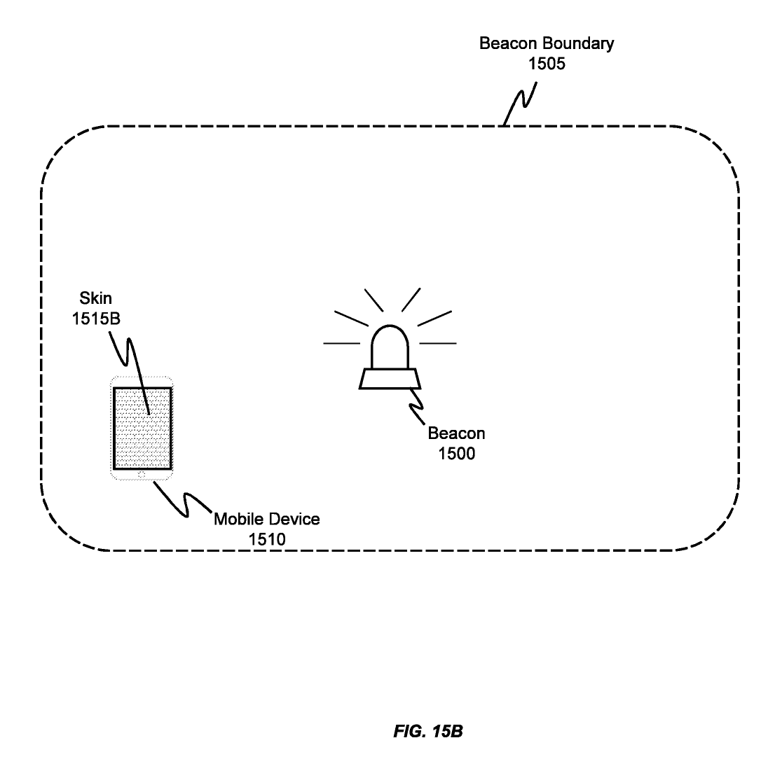

As discussed earlier, mobile device 1400 is able to change which application (or application settings) is currently executing based on its location. For instance, suppose a user to walking through a mall. As the user nears a particular store, application 1405, including content 1405A-D, can be dynamically changed to reflect the store content settings of that particular store. As the user continues walking and nears another store, then application 1405 can be updated to reflect that store's content settings, as described earlier. Similar to how content 1405A-D can change based on the merchant's settings, so too can skin 1410. That is, skin 1410 can also dynamically change in response to mobile device 1400 being proximate to a particular merchant's store (or to any other beacon). FIGS. 15A and 15B illustrate an example scenario of an application's skin updating in response to the mobile device being proximate to a beacon.

FIG. 15A shows a beacon 1500, which can include any of the beacons discussed thus far. Beacon 1500 is associated with a beacon boundary 1505 (e.g., a GPS location, geofence area, etc.). As an example, suppose beacon 1500 is a merchant's store. In some cases, beacon boundary 1505 can be the physical layout of the merchant's store. In another case, beacon boundary 1505 can be the wireless network of the merchant's store. For instance, the merchant's store can include a wireless router that allows customers, employees, or other users to connect wirelessly to the merchant's network. In some cases, the wireless network extends beyond the confines of the merchant's store (e.g., the wireless signal can extend outward until the signal strength dies). In such scenarios, therefore, the beacon boundary 1505 may not be limited to the merchant's store location, but rather can extend even further outward and is based on the merchant's wireless network strength. Of course, other boundaries may be used as well.

Accordingly, beacon boundary 1505 can include any type of boundary, regardless of whether it is a physical boundary (e.g., the store layout) or a network or other type of boundary. In this regard, beacon 1500 can be associated with any type of beacon boundary 1505.

FIG. 15A also shows a mobile device 1510 that is currently outside of the beacon boundary 1505. As an example, mobile device 1510 may be physically located outside of a merchant's store, or mobile device 1510 may be too far removed from the merchant's wireless router such that mobile device 1510 is not able to connect to the merchant's wireless network.

Here, mobile device 1510 is shown as displaying a skin 1515A (e.g., the diagonal lines represent the skin), which is an example implementation of skin 1410 from FIG. 14. That is, mobile device 1510 is executing an application that is associated with skin 1515A. FIG. 15A also shows that mobile device 1510 is undergoing movement 1520 so that mobile device 1510 will eventually enter the confines of beacon boundary 1505. As an example, a user, who is holding mobile device 1510, may be walking through a mall and may be approaching a particular store.

FIG. 15B shows the scenario in which mobile device 1510 has moved to be within the confines of beacon boundary 1505. FIG. 15B also shows that, in response to mobile device 1510 being within beacon boundary 1505 (i.e. moving into the boundary constitutes a type of triggering condition), the skin 1515B has changed appearance (or its audio characteristics have changed). For instance, whereas skin 1515A was symbolically shown as having diagonal lines, skin 1515B is shown as having a brick-like appearance. Of course, these visualizations are provided for example purposes only and should not be considered limiting. Furthermore, as used herein, changes to an application's skin should be interpreted broadly to mean any kind of change in visual appearance and/or in audio characteristics.

In this scenario, the mobile device 1510 experienced a particular triggering condition (i.e. entering beacon boundary 1505). In some cases, the application executing on mobile 1510 changed so as to reflect this new condition. For instance, because mobile device 1510 is now sufficiently proximate to beacon 1500 (i.e. mobile device 1510 is located within beacon boundary 1505), then the application executing on mobile device 1510 changed. In some cases, the mobile device 1510 changed from executing one application (e.g., application A) to executing an entirely new application (e.g., application B). In other cases, the application's settings were changed to as to reflect new, updated settings in response to being near beacon 1500. In addition to the application changing, the skin 1515B also changed to reflect the triggered condition. These skin changes include any of the changes discussed thus far.

In some embodiments, an application can be associated with a default skin that includes default visual parameters, attributes, or characteristics. As such, when an application is first executed, the default skin can be visually rendered. As one or more triggering conditions occur, however, the default skin can either be updated or replaced by a modified skin that is modified to reflect the triggering conditions, as described earlier. In some embodiments, the default skin can be associated with a particular user's login information. In this regard, a user can login to the application and can set, edit, modify, or otherwise customize the default skin that is to be used when the application is initially executed. In some embodiments, this default skin is the skin that will be used first when the application is first executed. Any triggers can then cause updates or modifications to the default skin. Alternatively, entirely new skins can be used in response to the triggers.

As described earlier, another triggering condition is based on time. For instance, suppose the user is using the application during a particular seasonal holiday (e.g., Christmas). In this case, the skin can be dynamically updated to reflect attributes associated with that seasonal holiday (e.g., Christmas trees, Santa Claus, presents, etc.). In other embodiments, the skin may be dynamically modified based on other time-dependent factors. For instance, the skin can be changed at dusk or twilight (e.g., night versus day time hours). The dimness or brightness of the skin can also be modified based on these time factors. Furthermore, new pages to the application can be added or existing pages to the application can be removed based on any factor, including time factors.

In situations where the triggering condition is the elapse of a particular time period (e.g., the time period is every 5 minutes, 10 minutes, 30 minutes, etc.) then the skin can also update in response to the start or end of a time period.

In some embodiments, the mobile device or other entity (e.g., a cloud service) is able to maintain a list of skins or skin modifications that are available for the mobile device to apply. That is, a database or other repository may be maintained, where the database includes details describing a list of one or more skins that can be applied when triggering conditions occur. This list includes the default skin as well as any number of other skins that have been created or designed for the application to use. In some cases, the list is organized based on beacon or beacon type. That is, each beacon may have one or more specific skins associated with it. As such, when the mobile device nears the beacon, the mobile device can fetch, query, or otherwise poll the database to acquire a skin that is associated with the beacon. Of course, any number of skins and beacons may be maintained within the database. Accordingly, in response to the occurrence of a triggering condition (e.g., the mobile device becoming proximate to a beacon or location), then the database can be consulted and a skin from the database can be applied to the application currently executing on the mobile device.

In some cases, not only is the background skin portion of the application updated, but the buttons and other control elements of the application are also updated/modified (i.e. applying the application skin to an adaptive application includes modifying a visual appearance or audio characteristics of one or more control elements/buttons of the adaptive application). With reference to the Christmas example, the background skin portion of the application may be updated to visualize Christmas-themed elements. In addition to these changes, the buttons of the application can also be updated. For instance, a small Christmas tree or other Christmas-themed image can be added to the buttons in order to further illustrate the Christmas theme or new audio may be associated with the button.

In some cases, changing the skin also includes adding entirely new control elements to the application. For instance, new buttons can be added to the application to reflect the new skin and theme. An example of a new button includes, but is not limited to, a new button that, when selected, allows a user to randomly (or in accordance with a predefined pattern) change the Christmas themed images to other Christmas themed images. That is, upon selection of the button, the user can change the skin to reflect other Christmas themed images. In this regard, the skin can be automatically updated, but it can also be modified by a user through the use of a newly added button to the application.

As another example of a time-based triggering condition, the skin can update when it is determined that the current day is the user's birthday. As such, the skin can reflect a birthday theme showing that the application recognizes the user's birthday.

Another triggering condition can include loyalty points or a loyalty relationship with a specific merchant. For instance, when the user reaches a certain number of loyalty points (e.g., as a result of shopping with the merchant), then the skin can reflect milestones of those loyalty points or loyalty level (e.g., every 100 loyalty points, every 1,000 loyalty points, etc. a special skin will be displayed for a period of time).

Changing the skin provides substantial and immediate benefits to a user. For instance, by dynamically changing the skin, the user is provided with an immediate visual cue that a particular triggering condition has occurred. That is, it allows the user to quickly and intuitively discern that he/she is proximate to a particular beacon (e.g., to receive a location-based promotion or information). As such, the user's experience in operating the mobile device will be improved.

Additionally, the disclosed embodiments bring about benefits to the administrators of the application. For instance, the administrators can provide a new update to the application skin without needing to submit a new application build to an app store. That is, updates can be rolled out or pushed out to end users in a quick and efficient manner without having to go through the app store and without having to go through all of the difficulties associated with normally updating an application.

In some embodiments, the skins that are maintained in the database can be shared among multiple different applications or beacons. That is, a cross-reference can be provided within the database to allow different beacons to use the same skin. In this regard, the skins can be used across different platforms and applications and thus are highly flexible and dynamic. In some embodiments, the cross-reference may include metadata or other information that is provided to slightly modify the skin when it is applied. For instance, a majority of the skin may be suitable for two applications, but one of the applications may be in one language and the other application may be in a different language. The database is able to maintain additional information with the cross-reference so that, when the skin is applied, one or more changes can be made (e.g., different language) while a majority of the skin is still used or maintained. In this regard, a single skin can be used for multiple different applications, and each one application can introduce a minor variation or change to the skin.

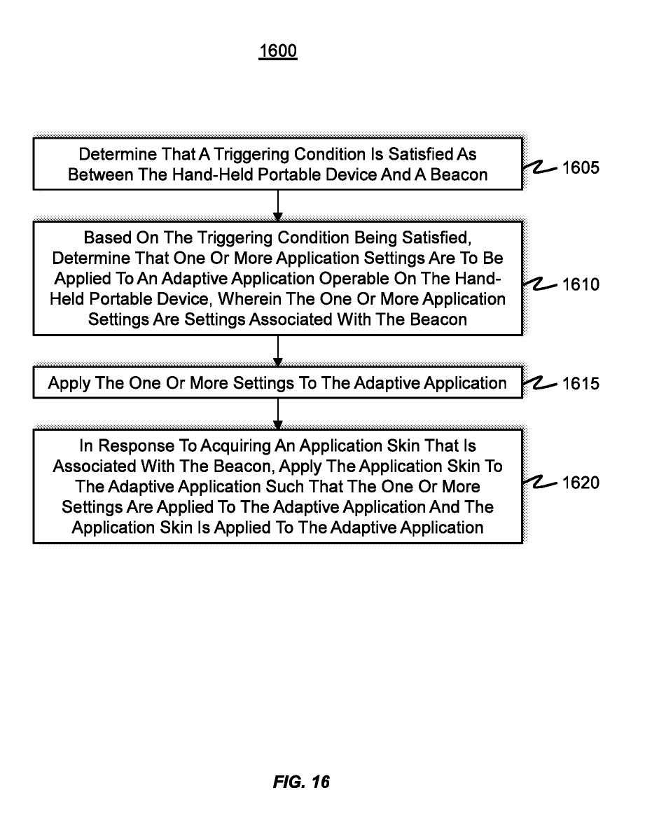

FIG. 16 illustrates a flowchart of an example method 1600 for dynamically updating an adaptive application (e.g., dynamically update the application's skin). Initially, method 1600 includes act 1605 in which a determination is made that a triggering condition is satisfied as between a hand-held portable device and a beacon.

Based on the triggering condition being satisfied, act 1610 includes determining that one or more application settings are to be applied to an adaptive application operable on the hand-held portable device, where the settings are associated with the beacon (e.g., a merchant's application settings). In act 1615, the settings are applied to the adaptive application.

Additionally, in response to fetching or acquiring an application skin that is associated with the beacon (e.g., from the previously described database), the application skin is applied to the adaptive application. In this regard, both the settings and the application skin are applied to the adaptive application.

It will be appreciated that the different merchants or organizations may use different techniques for specifying which skins they would like to use. For example, the organizations may be able to access a back-end server associated with the application. They may also be able to access a software development kit (SDK). Through any number of interfaces or back-end interfaces, the organizations (or an agency on their behalf) may specify tags (or other metadata) used in building consumer interfaces (e.g., mobile applications) that will fetch or retrieve (e.g., from a server) customized settings (e.g., colors, image files, text, personalized information, translated information, sound, etc.).

Some embodiments are able to further expand on the personalization of the application. For instance, instead of just modifying a look and feel of an application (e.g., colors and brand images/logos), other aspects of the application may be modified as well (e.g., a voice-based assistant may be added or modified). In this regard, a modified skin may additionally include new text, new audio (e.g., changes in language, tone, voice, etc.), photographic images, illustrations, and/or graphic elements. As an example, upon entering a particular type of establishment (e.g., a natural history museum), the application may be modified to reflect a dinosaur exhibit or certain environments. Modifications may be made not only to colors and logos but also to surrounding imagery, typography elements, voice and tone, spoken audio, and musical background.

It should be noted that various modifications and changes may be made without departing from the spirit and scope of the present invention. Consequently, these and other modifications are contemplated to be within the spirit and scope of the following claims.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. A hand-held portable device comprising:
a display;
one or more processor(s); and
one or more computer-readable hardware storage device(s) having stored thereon computer-executable instructions that are executable by the one or more processor(s) to cause the hand-held portable device to provide merchant specific functionality and visual appearance for a plurality of different merchants by causing the hand-held portable device to:
determine that a triggering condition is satisfied as between the hand-held portable device and a beacon;
based on the triggering condition being satisfied, determine that one or more application settings are to be applied to an adaptive application operable on the hand-held portable device, wherein the one or more application settings are settings associated with the beacon;
apply the one or more application settings to the adaptive application; and
in response to acquiring an application skin that is associated with the beacon, apply the application skin to the adaptive application such that the one or more application settings are applied to the adaptive application and the application skin is applied to the adaptive application.

2. The hand-held portable device of claim 1, wherein the beacon is a physical location.

3. The hand-held portable device of claim 1, wherein the beacon is a network location within a network.

4. The hand-held portable device of claim 1, wherein the skin includes one or more of a solid background color, a gradient fill color, a picture, a texture fill color, a pattern fill color, or one or more image(s).

5. The hand-held portable device of claim 1, wherein acquiring the application skin is performed by querying a database that includes a list of application skins associated with one or more beacons.

6. The hand-held portable device of claim 1, wherein applying the application skin to the adaptive application includes modifying a visual appearance of one or more control elements of the adaptive application.

7. The hand-held portable device of claim 1, wherein applying the application skin to the adaptive application includes adding one or more new control elements.

8. The hand-held portable device of claim 1, wherein the triggering condition includes a proximity between the hand-held portable device and the beacon satisfying a proximity threshold.

9. The hand-held portable device of claim 1, wherein the triggering condition includes an elapse of a particular time period.

10. The hand-held portable device of claim 1, wherein the application skin visualizes a theme associated with the beacon.

11. A method for dynamically updating an adaptive application, the method being implemented by a hand-held device and comprising:
determining that a triggering condition is satisfied as between the hand-held device and a beacon;
based on the triggering condition being satisfied, determining that one or more application settings are to be applied to an adaptive application operable on the hand-held device, wherein the one or more application settings are settings associated with the beacon;
applying the one or more application settings to the adaptive application; and
in response to acquiring an application skin that is associated with the beacon, applying the application skin to the adaptive application such that the one or more application settings are applied to the adaptive application and the application skin is applied to the adaptive application.

12. The method of claim 11, wherein the beacon is a physical location or, alternatively, the beacon is a network location within a network.

13. The method of claim 11, wherein the skin includes one or more image(s).

14. The method of claim 11, wherein the skin includes a picture.

15. The method of claim 11, wherein the triggering condition includes a proximity between the hand-held device and the beacon satisfying a proximity threshold.

16. One or more hardware storage device(s) having stored thereon computer-executable instructions that are executable by one or more processor(s) of a hand-held device to cause the hand-held device to:
determine that a triggering condition is satisfied as between the hand-held device and a beacon;
based on the triggering condition being satisfied, determine that one or more application settings are to be applied to an adaptive application operable on the hand-held device, wherein the one or more application settings are settings associated with the beacon;
apply the one or more application settings to the adaptive application; and
in response to acquiring an application skin that is associated with the beacon, apply the application skin to the adaptive application such that the one or more application settings are applied to the adaptive application and the application skin is applied to the adaptive application.

17. The one or more hardware storage device(s) of claim 16, wherein the triggering condition includes an elapse of a particular time period or, alternatively, the triggering condition includes a proximity between the hand-held device and the beacon satisfying a proximity threshold.

18. The one or more hardware storage device(s) of claim 16, wherein the skin includes one or more of a solid background color, a gradient fill color, a picture, a texture fill color, a pattern fill color, or one or more image(s).

19. The one or more hardware storage device(s) of claim 16, wherein the beacon is a physical location.

20. The one or more hardware storage device(s) of claim 16, wherein the beacon is a wireless connection.
